(19) United States
(12) Patent Application Publication
(10) Pub. No.: US 2024/0249930 A1
(43) Pub. Date: Jul. 25, 2024

(54) Ion Beam Focusing

(71) Applicants: Thermo Fisher Scientific (Bremen) GmbH, Bremen (DE); California Institute of Technology, Pasadena, CA (US)

(72) Inventors: Dmitry Grinfeld, Bremen (DE); Eric Wapelhorst, Bremen (DE); Alexander Makarov, Bremen (DE); Michael Roukes, Pasadena, CA (US)

(21) Appl. No.: 18/156,502

(22) Filed: Jan. 19, 2023

(51) Int. Cl. H01J 49/06

(52) U.S. Cl. CPC H01J 49/063

(57) ABSTRACT

An ion focusing device comprising an ion collection element comprising a plurality of N curved electrodes extending around an axis of the ion collection element and an aperture on an axis of the ion collection element. A multipole ion guide adjacent the ion collection element and having a plurality of N elongate electrodes extending parallel to and around an axis of the multipole ion guide, wherein the axis of the multipole ion guide coincides with the axis of the ion collection element, wherein each of the N curved electrodes of the ion collection element are configured to receive a radio frequency, RF, signal having the same phase as an RF signal configured to be applied to at least one elongate electrode of the plurality of elongate electrodes of the multipole ion guide, and further wherein at least two of the N electrodes of the ion collection element are configured to receive RF signals of a different phase.

### TECHNICAL FIELD OF THE DISCLOSURE

The disclosure concerns ion guides and focusing devices, especially for use in gaseous environments.

### BACKGROUND TO THE DISCLOSURE

Ion guides are required to transport ions from locations where they are generated through to input portions of mass analyzers and on to other processing components. This may involve the passage of ions through high-pressure gas environments. RF funnels and RF carpets have been developed to achieve this. Ion funnels are usually cone-shaped ion guides made from ring-shaped discrete electrodes (see U.S. Pat. Nos. 6,107,628 and 7,888,635). RF carpets typically employ stripe electrodes laid out on a printed circuit board (PCB), (see M. Wada, Y. Ishida, T. Nakamura, Y. Yamazaki, T. Kambara, H. Ohyama, Y. Kanai, T. M. Kojima, Y. Nakai, N. Ohshima, A. Yoshida, T. Kubo, Y. Matsuo, Y. Fukuyama, K. Okada, T. Sonoda, S. Ohtani, K. Noda, H. Kawakami, I. Katayama, Slow RI-beams from projectile fragment separators, Nucl. Instrum. Methods B204 (2003) 570).

In both device types, the electrodes are closely spaced (typical dimensions are around 1 mm or less). This achieves a sufficiently strong RF electric field that keeps ions away from the material of the substrate or other supporting components (see S. Schwarz. RF ion carpets: The electric field, the effective potential, operational parameters and an analysis of stability. Int. J. Mass Spectrom. 299 (2011) 71-77). The electrodes are often biased to generate a DC field that drives the ions in a desired direction towards and along the structure.

Current RF carpets use a cylindrical pattern of concentric stripe electrodes to guide ions towards a center hole or aperture for extraction into high vacuum or other region for further processing. FIG. 1 shows a schematic diagram of a typical ion carpet 10 formed on a printed circuit board (PCB) substrate 20 with an aperture 50 at its center. A series of concentric circular electrodes (30, 40) have their centers aligned with the aperture 50. Typically, RF voltages are applied such that two neighboring stripes or electrodes are out of phase by 180 degrees. Electrodes 30 have the same phase RF signal applied to them and this RF signal is out of phase by 180 to the RF signals applied to electrodes 40 in this figure. This figure does not show the electrodes used to supply each ring with their RF signals or other voltages, but these are typically supplied using vias through the PCB. While initially used for ion capture in nuclear physics, ion carpets are increasingly used in mass spectrometry (see U.S. Pat. No. 7,365,317, WO2004021385, U.S. Pat. No. 5,572,035, US20210407785, and WO2014022301). These ion carpets are mainly used to focus ions at a border between regions of different pressures. Such concentric-ring ion carpets typically require at least two layers of PCB fabrication and multiple vias, which necessarily limits choice of materials for the substrate or PCB, especially when high-purity is required to limit ion-molecule reactions in gas-filled ion guides. Typical concentric geometry creates poorly balanced fields that can result in unwanted ion scattering. To avoid this effect, features are made as small as possible, which further complicates fabrication.

Patent application RO134663 and related document (A. Rotaru et al. Int. J. Mass Spectrom. 478 (2022) 116858) describe a further ion carpet design. This ion carpet does not require vias and so can be formed using a single layer of PCB metallization. This design focuses ions to a center aperture using a traveling wave.

Ion carpets and ion funnels have a minimum ratio, usually ˜3, for the diameter of the innermost aperture to a period of the RF structure. Otherwise, the RF field near to the aperture may be unbalanced and lead to extra pseudopotential barriers that may prevent ions from penetrating the aperture. J. B. Neumayr et al., The ion-catcher device for SHIPTRAP. Nuclear Instruments and Methods in Physics Research B 244 (2006) 489-500, describes a tip of a funnel, where an RF field extends from the periodic structure at a distance greater than the funnel radius, so that the field amplitude becomes substantially non-zero on the optical axis.

FIG. 2 shows a simulation of an RF pseudopotential near to an aperture 50 in the center of a concentric-ring ion carpet. The innermost RF ring predominantly generates the field on the axis, while the next ring with an opposite RF phase is located substantially farther from this axis when compared with the diameter of the ring. This figure illustrates how the RF field becomes unbalanced with the pseudopotential barrier occurring on both sides of the aperture. Graph A corresponds with an ion carpet with a 1.0 mm internal diameter and a stripe period of 1.0 mm. Graph B corresponds with an ion carpet with a 2.0 mm internal diameter and a stripe period of 1.0 mm (m/z 500, 400 Vpp, 5 MHz). This chokes ion flow, as shown in the ion path simulation of FIG. 3.

While effective in concentrating ions towards the center, ion guides typically rely on a DC potential difference applied to the aperture to transmit ions through PCB, with ions moving quite close to the edges of the aperture and therefore prone to scattering and other ion losses. This requires a further reduction in PCB thickness or increasing the diameter of the aperture. Furthermore, ion carpets may not easily couple with downstream devices. The downstream devices may require an increase in the size of their inner diameters (or ion input regions) so that they are larger than the aperture of the ion carpet and can adequately receive a high proportion of the ions without significant losses.

To transfer ions through the aperture of an ion carpet with an unbalanced RF field, a DC gradient is usually applied both along the ion carpet (or funnel) and between the smallest ring and a remaining portion of the funnel. The solution is not ideal, as the DC gradient delivers extra energy to the ions. The transmittance for low m/z ions reduces as the pseudopotential barriers for such ions are increased.

Another known solution is to reduce the period of the periodic RF structure so that it is smaller than the radius of the aperture. This is technically challenging for small (˜0.1 mm) apertures. Losses on the aperture may be reduced by making PCB exceedingly thin (less than the ID of the ion aperture). However, this can be very difficult to manufacture for very small aperture devices.

Therefore, apparatus and operating techniques are required to address these challenges.

### SUMMARY OF THE DISCLOSURE

An ion focusing device is formed from a first component that channels ions through an aperture, opening or ion path into a second component that forms a tight ion beam. These components contain electrodes that are coupled together so that individual electrodes from the first component receives a radio frequency (RF) signal having the same phase as that received by individual electrodes of the second component. Furthermore, the ions are focused by applying different phase signals to adjacent electrodes, e.g., alternating around an axis where the ions pass.

The first component (an ion collection element) may be an ion carpet (i.e., having curved electrodes formed in a plane) with or without a planar substrate (the electrodes may be supported or free standing). Alternatively, the first component may be an ion funnel. The curved electrodes may be circular or preferably spiral (i.e., a flat spiral in the case of an ion carpet or take the form of a conical helix or stacked ring design in the case of an ion funnel). The second component is a multipole (preferably quadrupole) ion guide. An ion carpet has an advantage of relatively simple fabrication, especially with the PCB technology, but superior ion-optical properties are provided using a conical spiral or stacked circular ion funnel.

Where a substrate of the ion collection element is used, the aperture or open bore may be formed through this substrate. When the ion collection element is formed without a substrate then its structure may be mainly or wholly formed from the curved electrodes themselves. In this case, the aperture may be a region at the center of the ion collection element that is open and absent any portion of the curved electrodes (or other material) allowing ions to pass through the ion collection element and into the second component (multipole ion guide).

Whilst different RF signals may be applied to corresponding electrodes of each component, preferably each curved electrode of the ion funnel or carpet (ion collection component) may be electrically connected to an elongate electrode of the multipole ion guide.

In an example implementation, the curved electrodes of the ion carpet or ion funnel may extend and form uninterrupted single electrodes of the multipole ion guide (i.e., a single part forming a curved electrode at one end and a straight of elongate electrode at the other). A transition point or electrical connection between the two ends may pass through an aperture of the ion collection component.

Preferably, the ion collection element and the multipole ion guide should be as close as possible. For example, a distance between the curved electrodes (i.e., a portion of the curved electrodes adjacent to the aperture) and the closest part of the elongate electrodes of the multipole ion guide should be no more than 0.5-1 of an inscribed diameter of the ion guide. The inscribed diameter may be the diameter of the ion path through the multipole ion guide.

In accordance with a first aspect, there is provided an ion focusing device comprising:
an ion collection element comprising:
   a plurality of N curved electrodes extending around an axis of the ion collection element; and
   an aperture on an axis of the ion collection element; and
a multipole ion guide adjacent the ion collection element and having a plurality of N elongate electrodes extending parallel to and around an axis of the multipole ion guide,
wherein the axis of the multipole ion guide coincides, lines up with, or is the same as the axis of the ion collection element, wherein each of the N curved electrodes of the ion collection element are configured to receive a radio frequency, RF, signal having the same phase as an RF signal configured to be applied to at least one elongate electrode of the plurality of elongate electrodes of the multipole ion guide, and further wherein at least two of the N electrodes of the ion collection element are configured to receive RF signals of a different phase. Preferably, the structure of the device has symmetry around the common axis of the two parts (ion collection element and multipole ion guide). Preferably, an imaginary rotation around this axis by 90 degrees changes the RF phases to electrodes to their opposites (by 180 degrees). A control circuit can provide these signals using electrical contacts. A system with such (ideal) symmetry has zero electric field gradient on the axis of symmetry and, therefore, no pseudopotential barriers are formed along this axis. Therefore, the problem of ion transmittance thorough the miniature central aperture is improved. The N curved electrodes may be free standing or formed on a substrate. When free standing, the aperture is formed by the N curved electrodes terminating with a gap between them around the axis of the ion collection element and preferably terminating the same distance from the axis. Where a substrate is used (e.g., a dielectric substrate) then the aperture may be formed through the substrate on the axis. The number N for the curved electrodes of the ion collection element is the same as the number N for the multipole ion guide.

Preferably, the N curved electrodes may lie on a surface of axial symmetry of the ion collection element. A surface of revolution may be co-axial with the multipole ion guide and this may host or support the curved electrodes (or be where they are located and self-supported). This surface may be embodied by a substrate or be an imaginary surface if no substrate is used, for example.

The aperture may be the narrowest region on the axis of the ion collection element, which is open for ions to pass towards the multipole ion guide.

Preferably, the ion focusing device may also comprise an RF voltage source configured or arranged to supply the RF signal(s) to the N curved electrodes such that these RF signals have the same phase as the RF signal(s) applied to the at least one elongate electrode of the plurality of elongate electrodes of the multipole ion guide. The same or a different RF voltage source may provide RF signal(s) to the at least one elongate electrode of the plurality of elongate electrodes of the multipole ion guide.

Preferably, a minimum distance between the curved electrodes and the corresponding ion guide electrodes may be less than 0.5-1 of the inscribed diameter of the ion guide.

Preferably, the plurality of N curved electrodes (preferably with N>2) may be separated by a constant distance along their lengths. This improves the electric field that guides the ions through the aperture.

Preferably, the N curved electrodes may terminate adjacent to the aperture of the ion collection element. The N curved electrodes may terminate around the aperture or the termination of the N curved electrodes forms the aperture itself.

Optionally, the N curved electrodes may terminate at an angular separation of 90 degrees or 180 degrees around the aperture (e.g., of the substrate). This improves the symmetry of the ion collection component and the RF field.

Optionally, each of the N curved electrodes may be connected (i.e., electrically connected) to one of the N elongate electrodes.

Preferably, the N curved electrodes may have adjacent electrical connections to the N elongate electrodes (e.g., ends of the elongate electrodes). This improves electrical coupling between the two components and simplifies the operation of the device because the same RF signal can be applied to individual electrodes from the ion collection component and the multipole ion guide.

Optionally, the ion collection element may have four curved electrodes and the multipole ion guide may have four elongate electrodes. The use of a quadrupole provides the improved symmetry with the least number of electrodes.

Optionally, the N elongate electrodes of the multipole ion guide may be distributed equally around the axis of the multipole ion guide, and wherein elongate electrodes at opposite positions around the axis are configured to receive an RF signal having the same phase and elongate electrodes at adjacent positions around the axis are configured to receive an RF signal at 180 degrees out of phase to each other. This further improves the symmetry of the electric field and so reduces ion losses and other inefficiencies.

Optionally, the N curved electrodes may be spirals, arithmetic or Archimedes spirals, conical helixes or circular. Curved electrodes may wind spirally. Curved electrodes may form flat or planar ion carpets or ion funnels but introduce complexities regarding electrode connections (separate circular electrodes may be required along the ion collection component each with their own electrical connection). Preferably, the N curved electrodes take the form of spirals (e.g., in a 2D plane) or of a conical helix (e.g., forming a helical ion funnel).

Optionally, the N curved electrodes may be configured to receive a direct current, DC, offset voltage relative to the N elongate electrodes of the multipole ion guide. When the N curved electrodes have an electrical connection to the N elongate electrodes of the multipole ion guide then a DC offset may be applied between another electrode of the ion collection component (e.g., an outer ring electrode) and the N elongate electrodes of the multipole ion guide.

Optionally, the ion focusing device may further comprise electrical connections between each of the N curved electrodes of the ion collection element and each of (or one of) the elongate electrodes of the multipole ion guide. This simplifies operation and construction of the electrical driving circuit. Preferably, at least one pair (e.g., all pairs) of a curved and an elongate electrode constitutes a single elongate electrode, which is straight on a part of its length and curved on the other part of its length.

Optionally, the electrical connections may pass through the aperture and may intersect with the N curved electrodes (e.g., ends of the N curved electrodes nearest to the aperture). These may be spring loaded, for example, or be formed from a fixed, permanent, or continuous connection.

Optionally, N may be an odd number. This may be achieved in some example implementations. N may be 3, 5, 7, 9, 11, etc.

Preferably, N may be an even number. This further improves symmetry of the electric field that guides the ions.

Optionally, the N curved electrodes may curve on plane. Therefore, the N curved electrodes each form at least part of a 2D spiral of an ion carpet.

Optionally, the N curved electrodes may form an ion funnel. Therefore, the N curved electrodes each form at least part of a 3D conical helix or a series of ever decreasing circular electrodes of an ion funnel.

Optionally, the ion collection element may further comprise a substrate around the aperture.

Optionally, the substrate may be glass or a printed circuit board, PCB. Other materials may be used.

Optionally, the substrate may be 0.2 mm to 2 mm thick. Other dimensions may be used.

Optionally, a volume within the multipole ion guide may be filled with a buffer gas. This may be argon or nitrogen, for example.

Preferably, the ion focusing device may further comprise one or more alignment holes in the ion collection element and/or the multipole ion guide. This alignment holes may be used to align the components more accurately.

Optionally, an internal diameter of the multipole ion guide may be 0.5 mm to 2 mm. Other dimensions may be used.

Optionally, the buffer gas may be at a pressure corresponding to a mean free path of ions in the range 0.01-10 times the inscribed diameter of the multipole ion guide.

Optionally, an internal diameter of the aperture may be 0.5 mm to 2 mm. Other dimensions may be used.

Optionally, the N curved electrodes and the elongate electrodes of the multipole ion guide may be configured to receive an RF signal at the same frequency and/or the same amplitude.

In accordance with a further aspect, there is provided a mass spectrometer comprising the ion focusing device as described above.

In accordance with a further aspect, there is provided an ion focusing device comprising:
a multipole RF ion guide comprising a number N of straight elongate electrodes extending parallel to and around an axis of the multipole ion guide and configured to receive a radio frequency, RF, and further wherein at least two of these electrodes are configured to receive RF signals of different phases;
a plurality of N curved elongate electrodes that lie on a surface of revolution around the axis of the said multipole RF ion guide, wherein
   the number of electrodes N is greater than two;
   the first end of each curved elongate electrodes is located at an end of one straight elongate electrode, and the said curved elongate electrode receives an RF signal in the same phase as the said straight elongate electrode;
   the curved elongate electrodes wind spirally around the axis of the RF ion guide while staying on the common surface of revolution;
   the second end of each curved elongate electrode is located at a greater distance from the axis of the RF ion guide;
   wherein, in operation, ions are repelled by the RF electric field generated by the plurality of the curved elongate electrodes and are converged to the multipole RF ion guide.

### BRIEF DESCRIPTION OF THE DRAWINGS

The disclosure may be put into practice in a number of ways, and preferred embodiments will now be described by way of example only and with reference to the accompanying drawings, in which:

FIG. 1 shows a schematic diagram of a known type of ion carpet;

FIG. 2 shows graphical results of a simulation of RF signals near an aperture of the ion carpet of FIG. 1;

FIG. 3. shows a graphical simulation of ion paths passing through the aperture of the ion carpet of FIG. 1;

FIG. 4. shows a schematic diagram of an ion focusing device according to an example implementation having spiral electrodes, including a front perspective view and a cross-sectional view;

FIG. 5 shows a schematic diagram of the ion focusing device of FIG. 4, including a signal generator for driving the ion focusing device;

FIG. 6 shows a schematic diagram of an ion focusing device according to an example implementation having circular electrodes, including a front perspective view and a cross-sectional view;

FIG. 7 shows a perspective view of electrodes forming an ion funnel and multipole ion guide of the ion focusing device;

FIG. 8 shows a perspective view of electrodes forming an ion carpet and multipole ion guide of the ion focusing device;

FIG. 9 shows a top view of electrodes forming an ion carpet of the ion focusing device;

FIG. 10 shows a photograph of an example ion collection element in the form of an ion carpet;

FIG. 11A shows a visual simulation of ion trajectories provided by the ion focusing device of FIGS. 4 and 5;

FIG. 11B shows graphical simulation results of ion energies as ions pass through the ion focusing device of FIGS. 4 and 5;

FIG. 12 shows a further visual simulation of ion trajectories passing through the ion focusing device of FIGS. 4 and 5 together with further example operating parameters;

FIG. 13 shows a schematic diagram of a system incorporating the ion focusing device; and

FIG. 14 shows a further schematic diagram of a system incorporating the ion focusing device.

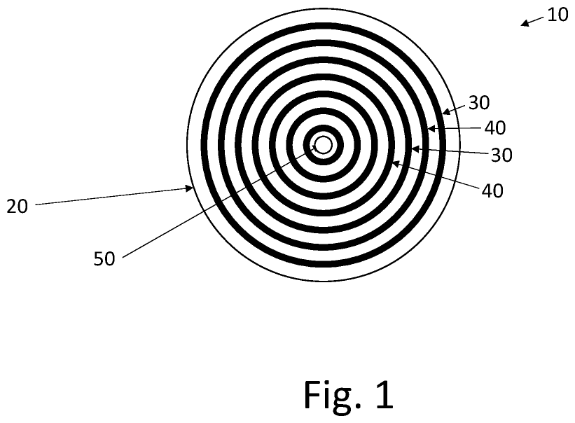

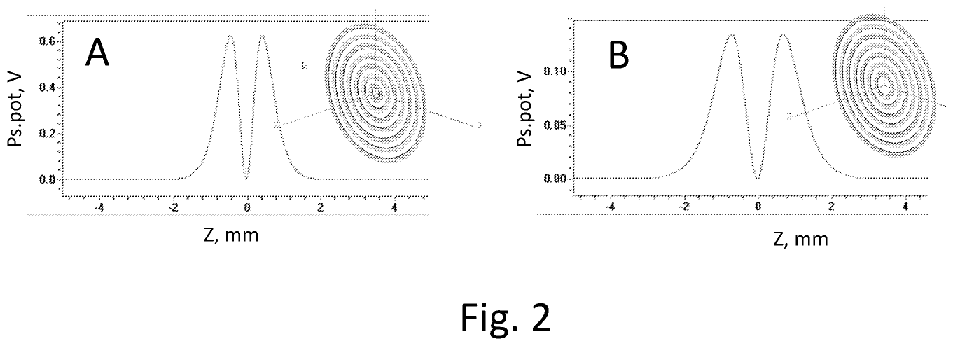

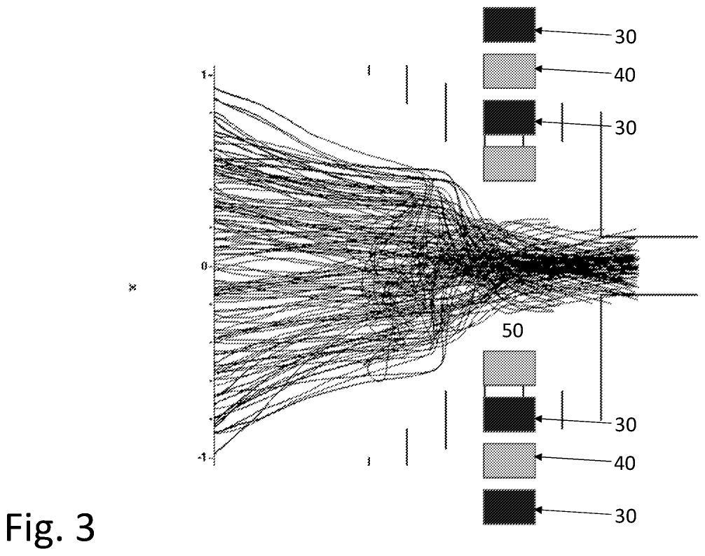

### DETAILED DESCRIPTION OF PREFERRED EMBODIMENTS

Existing ion collection elements such as ion carpets and ion funnels can compromise the focusing of ions and preclude ions from a tight focus on the axis of downstream devices. This adverse effect can be reduced or negated by placing a N-multipolar field from a miniature RF-only multipole ion guide aligned accurately into an opening in the ion carpet with DC coupling (i.e., applying a DC offset between at least a portion of the ion collection element and the multipole ion guide). The ion collection element also possesses a similar N-multipolar symmetry that matches the multipole. Preferably, N is an even number but an odd number of electrodes may also be used. Preferably, both the ion collection element and the multipole ion guide have the same number of electrodes and these are electrically coupled together or receive similar signals.

Focusing the ions in this way is very useful to reduce a phase volume of the ion flux/bunch from a wide entrance end (the ion collection element) towards a narrow exit end (the ion guide). This capability is advantageous in multiple technical applications, e.g., to achieve a soft landing of ions with micrometer spatial resolution.

The ion focusing or guide device comprising the ion collection element and the multipole ion guide, overcomes limitations of the prior art by implementing a spiral or concentric (circular) electrode ion carpet of ion funnel (ion collection element) with a miniature RF-only multipole ion guide located at the ion collection element's extraction or central aperture.

In a particular embodiment an ion carpet or ion funnel with an aperture (either within a substrate or formed from a void or absence of electrode material) is coupled to a small, miniature or matching sized multipole (e.g., quadrupole) ion guide whose axis is orthogonal to the plane in which the ion carpet is arranged. An axis of the multipole ion guide is coaxial with the aperture (e.g., circular aperture) of the ion collection element. Therefore, an entrance of the ion guide is located in the same plane or immediately behind or after (along a flow of ions when in use) the aperture of the ion collection element so that the ions that pass through the aperture proceed directly into the entrance of the ion guide.

In an example implementation, the ion collection element preferably comprises four RF or conductive tracks (e.g., copper) configured to receive alternating RF signals of different phases. In one example implementation, conductive tracks on a substrate (e.g., a printed circuit board—PCB) form Archimedes spirals preferably having a constant distance or separation between the windings. The tracks converge close to, adjacent to or regularly arranged around a circular aperture of the ion collection element with an angular separation of 90 degrees between adjacent tracks. The ion collection element can be planar (e.g., an ion carpet) or the electrodes can also extend in a direction of an axis of ion travel (e.g., in the form of a conical helix forming an ion funnel with or without a substrate).

The RF signals applied to conductive tracks forming curved electrodes of the ion collection element have polarities or phases that match the polarity or phases of RF signals applied to elongated electrodes or rods of the multipole ion guide. The multipole ion guide's electrodes may be electrically connected to the spiral electrodes so that the RF frequency, phase, and the amplitude are the same as on the spiral tracks. Alternatively, the ion guide's electrodes may be disconnected from the spiral tracks and have different RF amplitudes and/or a different DC bias. However, in both variants or options, the RF frequency on the ion guide and the ion collection element (ion carpet or ion funnel) is the same with matched phases but with different phases on different electrodes.

The structure comprising the ion collection element and the ion guide has the multipole (e.g., quadrupole) symmetry around a common axis. For the quadrupole implementation, this means that an imaginary rotation around this axis by 90 degrees changes the RF phases applied to the electrodes and/or rods so that their sign is reversed or opposite (i.e., changed by 180 degrees). Therefore, a system with a quadrupole symmetry has exactly zero electric field gradient on the axis of symmetry and, therefore, no (or very little) pseudopotential barriers are formed along this axis. This further improves, the problem of an otherwise reduced ion transmittance thorough the typically small central aperture. To avoid possible ion stalling by inhomogeneous surface potential, preferably a DC field is created along the quadrupole by field sag from inclined electrodes, for example, as described in U.S. Pat. No. 5,847,386. Such electrodes are preferably manufactured together with quadrupole electrodes in a single machining step (e.g., formed by wire erosion).

Preferably, a volume inside the ion focusing device (within the multipole ion guide and in front of the adjacent ion collection element) may be filled with a buffer gas that enables collisional ion cooling and facilitates ion flux/bunch convergence towards the axis.

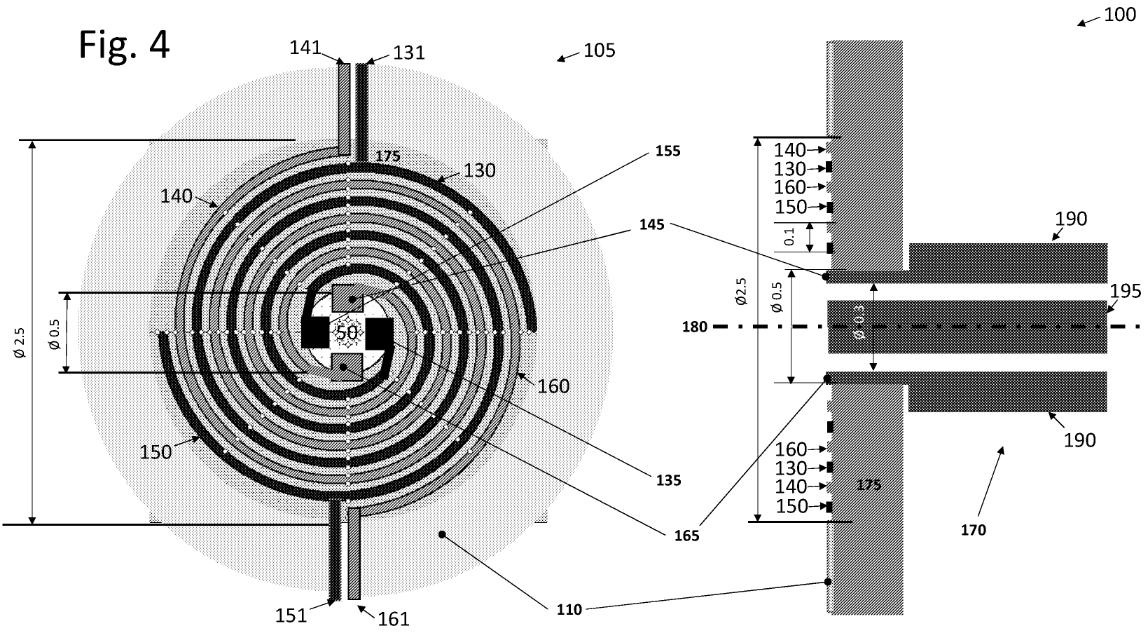

In an example implementation of an ion focusing device 100 that is shown in FIG. 4, an RF-only multipole ion guide 170 (quadrupole) protrudes from the back of a circular aperture 50 formed within dielectric material forming a substrate 175 of a spiral ion carpet 105. The substrate 175 may be formed from a printed circuit board (PCB) with electrodes formed using a suitable etching or ablation technique.

For example, a conductive film may be deposited on one side of a dielectric substrate 175 by any standard technology (e.g., chemical deposition, magnetron deposition, etc.), or a metal film may be glued to the dielectric substrate. Formation of RF-carrying tracks may be performed via chemical etching with a prior deposited stopping mask. Alternatively, the conductive film may be removed from the gaps between the RF-carrying tracks via laser cutting or laser ablation, or any sort of mechanical cutting.

A front view of the ion focusing device 100 is shown on the left side of FIG. 4. A side view of the ion focusing device 100 is shown on the right side of the figure. As the multipole ion guide 170 is behind the ion carpet 105 then it can only be seen on the right side, which shows the ion carpet 105 and adjacent quadrupole ion guide 170.

The electrodes 130, 140, 150, 160 of the ion carpet 105 may be formed by partially etching a metal layer 110 (e.g., copper) formed on the substrate 175. In this example ion focusing device 100, the same signals are provided to the electrodes 130, 140, 150, 160 of the ion carpet 105 as applied to electrodes or rods 190, 195 of the multipole ion guide 170 because there is an electrical connection between the ion carpet spiral electrodes 130, 140, 150, 160 (curved electrodes) and the rods 190, 195 (elongate electrodes). To achieve this, electrode contacts 135, 145, 155, 165 are formed at the end of the ion carpet spiral electrodes 130, 140, 150, 160. These electrode contacts 135, 145, 155, 165 are located at the inner ends of the ion carpet spiral electrodes 130, 140, 150, 160 equally spaced (both in distance and angular distribution) around and on the edge of the aperture 50 that pass through the substrate 175. Again, the electrode contacts 135, 145, 155, 165 may be formed by etching the metal layer 110 on the substrate 175.

As can be seen from the left side of FIG. 4, the electrode contacts 135, 145, 155, 165 at least partially extend beyond the edge of the circular aperture 50 but leave an unobstructed path for ions to pass through the center portion of the aperture 50. End portions of the rods or elongate electrodes 190, 195 extend into the aperture 50 from an opposite side of the substrate to the side on which the ion carpet electrodes 130, 140, 150, 160 are formed on the substrate 175 and make electrical contact with the electrode contacts 135, 145, 155, 165. This forms an electrical contact between individual ion carpet curved or spiral electrodes 130, 140, 150, 160 and individual electrodes or rods of the multipole ion guide. A firm electrical contact may be made between the electrode contacts 135, 145, 155, 165 and the individual electrodes or rods of the multipole ion guide by biasing elements (not shown in this figure) such as spring contacts or by the ends of the individual electrodes or rods being biased away from the axis 180 of the device 100 to apply an axial pressure against the inner surface of the aperture 50 and against the electrode contacts 135, 145, 155, 165. This may form an interference fit or further electrical bonds (e.g., soldering) may be applied to join the contacts 135, 145, 155, 165 with the electrodes 190, 195. However, the most preferable way of connecting could be simply external connection of phases at the RF generator.

The RF signals may be provided to the ion carpet electrodes 130, 140, 150, 160 by supply contacts 131, 141, 151, 161, respectively. The supply contacts 131, 141, 151, 161 may also be formed by etching the metal layer 110 (e.g., copper) on the substrate 175. The supply contacts 131, 141, 151, 161 are located at an outer edge of the ion carpet 105 in this embodiment. In this example implementation, the supply contacts 131, 141, 151, 161 are formed as two groups 131, 141 and 151, 162 at opposite sides of the ion carpet 105 but other configurations may be used, e.g., at other locations around or within the substrate 175. The substrate 175 is circular in this example implementation but may take other forms (e.g., square, rectangular, polygonal, etc.).

As can be seen from FIG. 4, the ion carpet electrodes 130, 140, 150, 160 extend beyond the point of external connection (supply contacts 131, 141, 151, 161) in order to increase the active area of the ion collection element (ion carpet 105). In other example implementations, these extensions could be by up to another 90 degrees until they hit the external connections on the opposite side.

FIG. 4 illustrates how all RF connections are made from the front side of the substrate 175 (i.e., on the same surface as the curved electrodes are formed), requiring only a single metal layer 110 on the PCB. Alternative manufacturing techniques may use metal printing on a thin glass slide (as the substrate 175) or ablation from the front side. No vias are required and a glass slide, in particular, could be formed as thin as 0.2 mm.

The aperture 50 in the substrate 175 facilitates alignment of the multipole ion guide 170 with the spiral ion carpet 105. To this end, the inner surface of the aperture 50 has no metal coating and pointed ends (extending into the aperture 50) of the quadrupole electrodes 190, 195 are tightly pressed into the aperture 50 as shown in FIG. 4.

A remaining portion of the metal layer used to form the curved electrodes 130, 140, 150, 160 is shown as metal layer 110 around the edge of the substrate 175. A DC bias may be applied to this metal layer 110. A DC bias or potential difference may be formed with the elongate electrodes 190, 195 of the multipole ion guide. This DC bias at least partially drives the ions from the ion collection element through the aperture 50 and into the multipole ion guide. Such a DC arrangement may be used with any type of ion collection element and multipole ion guide including the ion carpet 105 and quadrupole 170 examples.

In a further example fabrication, metallization may be carried out on the inner cylindrical surface of the aperture 50 with subsequent prolongation of tracks to the periphery of the opposite side of the ion carpet substrate (PCB) 175. However, this requires more complex techniques and manufacturing steps.

FIG. 4 also shows some general example dimensions for the ion focusing device 100. In particular, the active portion of the ion carpet (i.e., covered by electrodes) has a diameter of 2.5 mm (e.g., 2-3 mm). The aperture has a diameter of 0.5 mm (e.g., 0.25-1 mm). The curved (spiral) electrodes may be separated by around 0.1 mm and have a similar width. Other dimensions may be used.

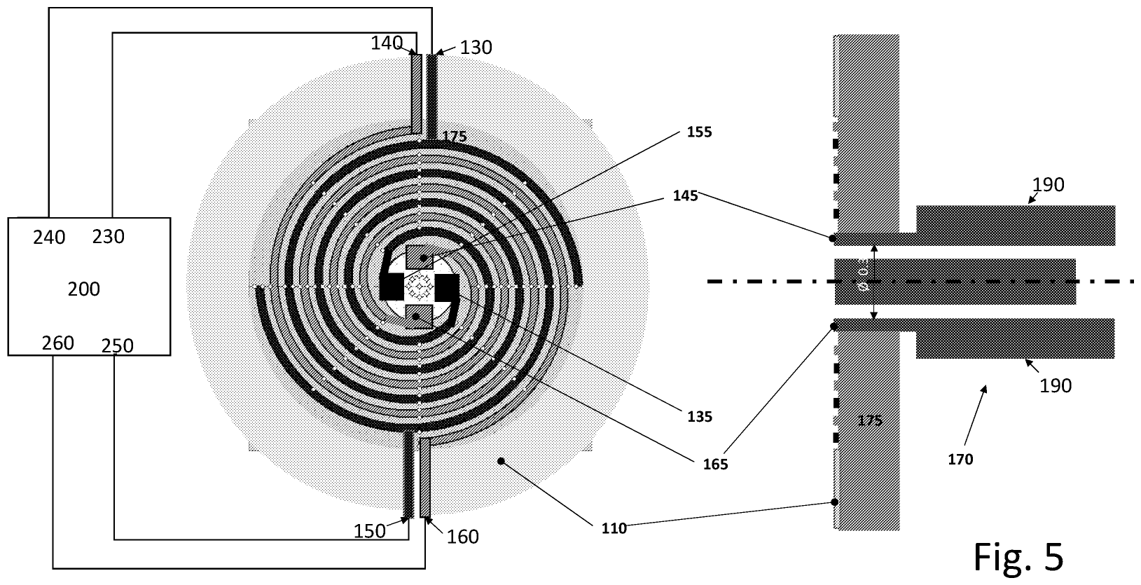

FIG. 5 shows a further schematic illustration of the ion focusing device 100. However, this figure also includes a signal control component 200 that can delivery RF and DC signals to each electrode pair (ion carpet and multipole ion guide). In this example implementation, the signal control component 200 has four outputs 230, 240, 250, 260 in electrical connection with the four supply contacts 131, 141, 151, 161, respectively. It is noted that a similar signal control component 200 may be used with other types of ion collection elements, including ion carpets with circular electrodes and ion funnels.

The signal control component 200 can apply the DC bias or potential difference to generate an electric field configured to drive ions to the center of the aperture 50 of the ion carpet. This field is created by applying a voltage between a previous ion guide or source of the ions (e.g., an RF-only multipole with inscribed radius of 2-3 mm and a typical axial field) and the ion carpet 105 (or other type of ion collection element), as well as between the ion carpet 105 and multipole ion guide 170. A DC bias of 1V to 10V (preferably 2V) may be used depending on ion type, for example. However, it is highly desirable that ions approach the ion carpet 105 at energies close to thermal, otherwise strong scattering could result in ion losses. This is achieved by ensuring that collisional thickness of the preceding ion guide exceeds 0.2 mm*mbar, and most preferably 1 mm*mbar or above.

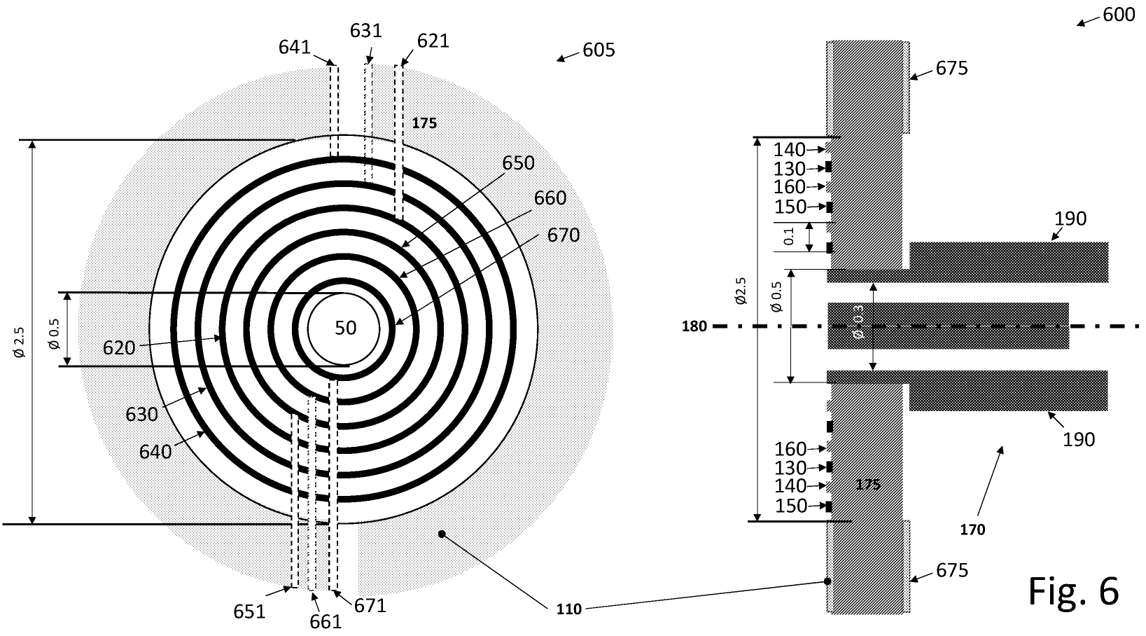

FIG. 6 shows a further example implementation of an ion focusing device 600. Similar components are provided with the same reference numerals as shown in FIGS. 4 and 5. However, circular electrodes 620, 630, 640, 650, 660 are used instead of spiral electrodes. Each circular electrode has a respective supply contact 621, 631, 641, 651, 661 (shown in dashed lines) located on a rear or opposite side of the substrate 175 (or alternatively, through a further layer within the substrate 175) to the circular electrodes 620, 630, 640, 650, 660. Connections between the circular electrodes 620, 630, 640, 650, 660 and their supply contacts 621, 631, 641, 651, 661 are formed using vias passing through the substrate 175. Therefore, where a PCB is used to fabricate this type of ion carpet 605 then this requires at least two metal layers 110, 675.

Dissipation of ion energies upon focusing into the downstream multipole ion guide 170 (e.g., the miniature quadrupole) may be achieved by ensuring that the local mean free path at the entrance to the multipole ion guide 170 is substantially of the same order of magnitude or smaller than the inscribed diameter of the guide. For example, in the ion focusing devices of FIGS. 4, 5 and 6 where the internal diameter of the aperture of the ion carpet 105 and the multipole ion guide 170 is around 0.5 mm, then an advantageous buffer gas pressure of 0.1-1 mbar may be provided. Such pressure may be created by leaking gas from the side of a downstream ion guide.

The example devices shown in FIGS. 4 to 6 show spiral and circular ion carpets and RF-only multipole ion guides providing a quadrupolar field (where electrode number N=2M=4). However, alternative implementations may use any number of multipoles of the form 2M multipoles (or electrodes), where M=2, 3, 4, 6, . . . ).

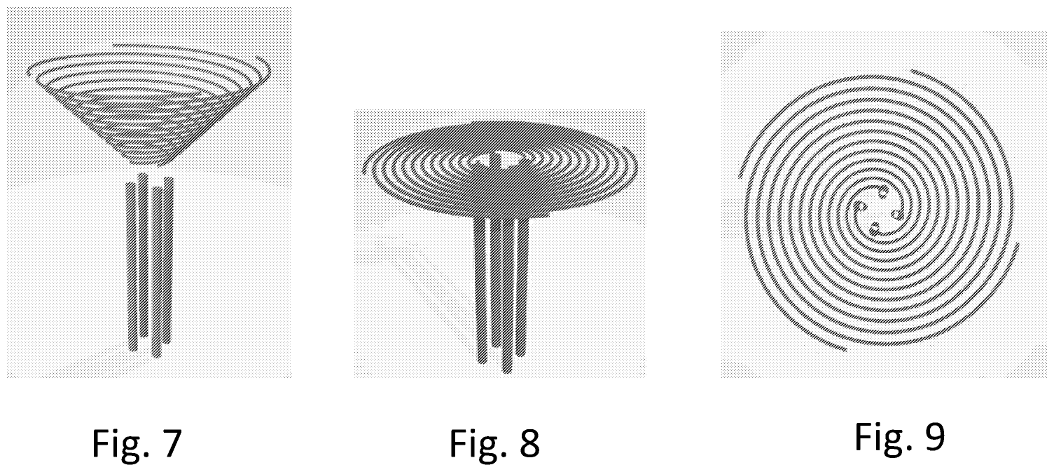

FIG. 7 shows a perspective schematic diagram of the electrode arrangements for an ion funnel with the curved electrodes taking the form of a conical helix. The elongate electrodes of the multipole ion guide (a quadrupole in this example but other numbers of electrodes may be used) are also shown. The curved electrodes of the ion collection device and the elongate electrodes of the multipole ion guide are not shown as being fused together or forming an electrical connection between each other in this example. However, this may also be achieved in other example implementations.

FIG. 8 shows a perspective schematic diagram of corresponding electrodes of an ion carpet example implementation. FIG. 8 corresponds with similar example devices shown in FIGS. 4 and 5 but the electrical connections are absent in this figure for clarity. FIG. 9 shows a plan view of example curved electrodes of an example ion collection element illustrating electrode contacts 135, 145, 155, 165. No substrate is shown in FIG. 9 but this option may be added in other examples. The curved electrodes may be supported using different mechanisms including the use of the electrode contacts to form a rigid supporting frame.

The following describes an example manufacturing process for the ion focusing device. Optionally, the ion focusing device may be formed from conductive wires held by a 3D printed (or other) dielectric support equipped by grooves or holder of the spiral shape. Optionally, the 3D printed dielectric support may be removed after the curved electrodes are shaped. Some curved electrodes are optimally clamped together to enhance mechanical rigidity.

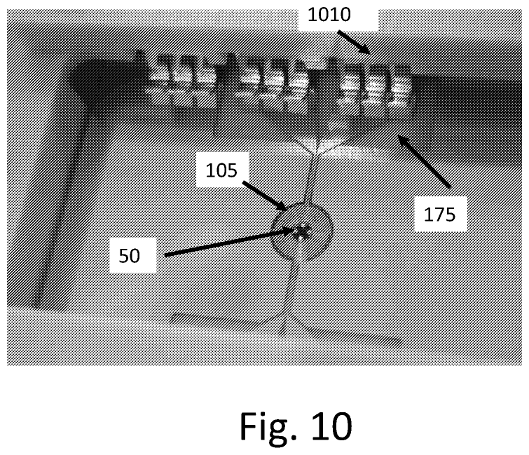

FIG. 10 shows a photograph of an example ion carpet 105 formed on a substrate 175 that may be glass or a PCB (e.g., fiber glass), preferably with low outgassing in vacuum. The aperture 50 is shown in the center and external electrical connections 1010 to the curved electrodes 130, 140, 150, 160 are shown at the top of this photograph.

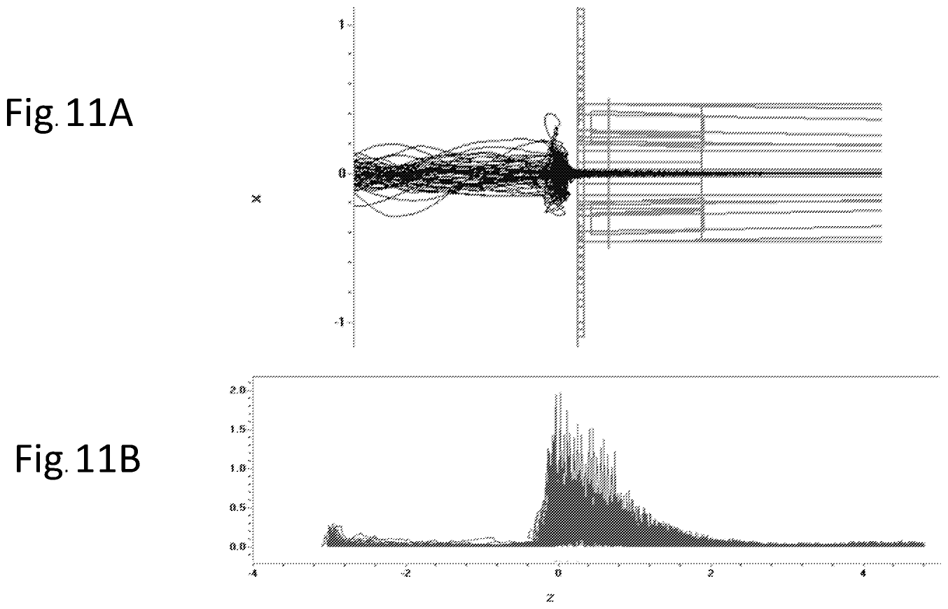

FIG. 11A shows a visual simulation of ion trajectories provided by the ion focusing device of FIGS. 4 and 5. This figure demonstrates how ions are effectively collected by the ion collection element and directed through the aperture 50 and into the multipole ion guide. FIG. 11B shows graphical simulation results of ion energies as ions pass through the ion focusing device of FIGS. 4 and 5 corresponding with the visual simulation of FIG. 11A.

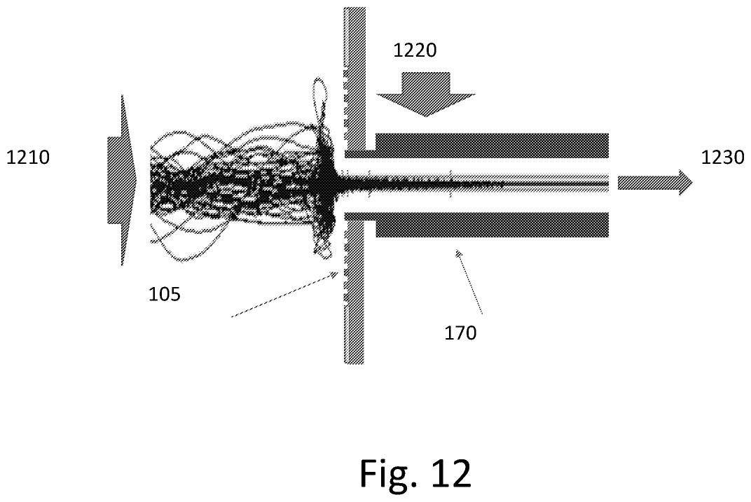

FIG. 12 shows a further schematic diagram of the ion focusing device 100 including an example ion carpet 105 and multipole ion guide 170 but illustrating operating parameters. A dispersed incoming ion beam 1210 provides a source of ions. The ion carpet 105 collects this incoming ion beam 1210 and directs the ions through the aperture 50 and into the multipole (quadrupole) ion guide 170. Buffer gas (e.g., argon or nitrogen) is provided through an inlet 1220. In this example, ion trajectories are shown as a dispersed incident ion beam, which converges into the multipole ion guide 170. The ion beam is further cooled via collisions with the buffer gas. A concentrated gas-cooled ion beam 1230 is provided at an exit of the multipole ion guide 170 for onward use.

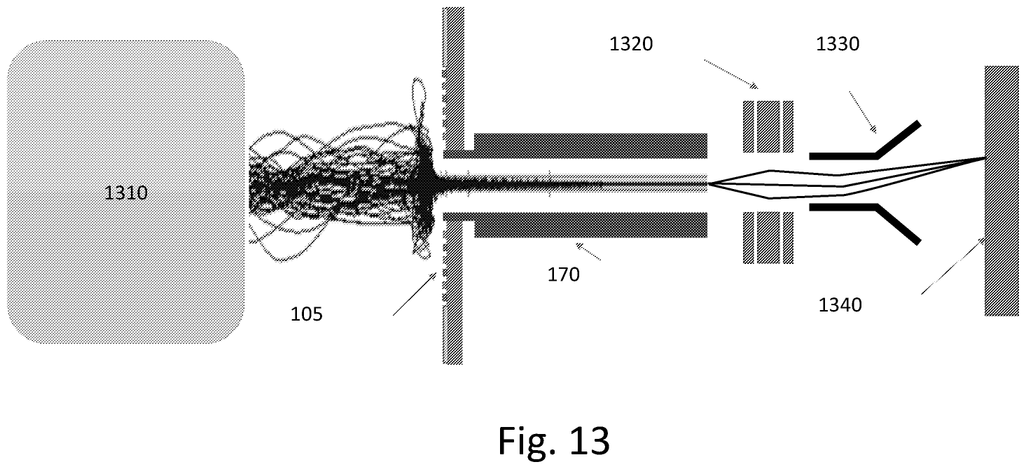

The described ion focusing device 100, 600 may be incorporated into further apparatus including that used as a part of a soft-landing apparatus. FIG. 13 shows a schematic diagram of an example system incorporating the ion focusing device 100, 600. This diagram provides high level overview of an experimental apparatus used to provide an ion soft-landing on a miniature substrate. The ions may be mass-filtered in a suitable mass spectrometer 1310 (e.g., an Orbitrap™ Exploris™ 480 mass spectrometer or a quadrupole mass filter). The ions pass on to the ion carpet 105 and proceed further to the multipole ion guide 170. The compressed and gas-cooled ion beam is further focused by an ion lens 1320. The ion beam may be deflected by an X/Y rastering deflector 1330 to a designated point of an ion deposition substrate 1340, where the ions are deposited at low kinetic energies.

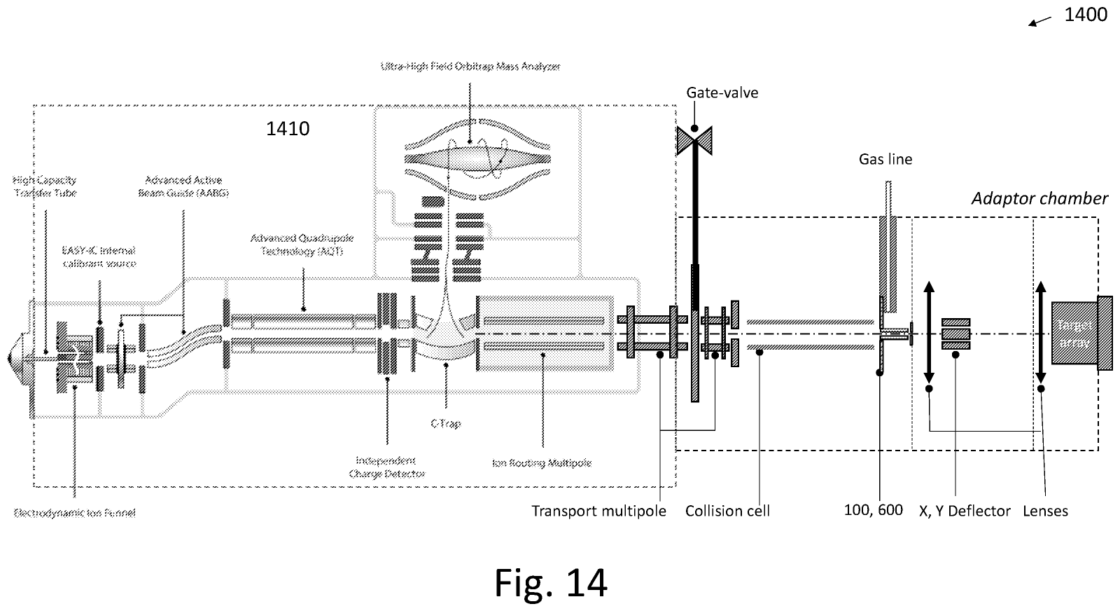

FIG. 14 shows a schematic diagram of further example system incorporating the ion focusing device 100, 600. In this apparatus 1400, ions are produced in an ion source of a mass spectrometer 1410, transported into vacuum and optionally mass selected or measured. For soft-landing use, ions are directed from the mass spectrometer 1410 via a set of ion guides into a collision cell where they are cooled to form ion thread having an outer diameter of around 100-200 microns. The ion focusing device may be used to compress an initial beam down to 10-30 microns OD. The resulting ion beam may be further transported to a target array, where it may be deposited at controllable energy (preferably corresponding to acceleration below 10V). The location of landing may be adjusted using an X-Y rastering system with a spot size tuned using ion-optical lenses, for example.

A broad range of ion sources is available using this mass spectrometry technique. Therefore, essentially any type of analyte may be delivered in this manner. This may include ions of elements to small and large organic and inorganic molecules, up to peptides, proteins, DNA/RNA, protein and protein/DNA/RNA complexes and even intact viruses and bacteria.

Up to 10s of picoAmps of ion current may be delivered in each 10-micron spot, corresponding to 10s-100s attomole/second or 0.1-1 monolayers of molecules per second.

Uses of the apparatus described above may include:
Soft landing on an electron microscopy target. 100s to at least 1000s of distinct spots may be created this way for samples of intact proteins and protein complexes in the native state. This in its turn greatly increases throughput, e.g., cryoelectronic microscopy.
Soft landing on nano-electromechanical devices (NEMS) using a short-focus ion lens. This enables the concentration of ions solely on NEMS cantilevers and increases sensitivity by orders of magnitude.
Provides injection into an array of mass analyzers, including electrostatic traps or RF ion traps made at sub-mm scale using technologies such as MEMS.
Direct writing of 3D structures for manufacturing of (bio)sensors, DNA, protein and virus chips.
Chemical and/or biological modification of surfaces by ion beams.
Chemical doping of organic light-emitting diodes with high spatial resolution.

The system provides at least the following advantages:
Lower ion losses
Higher ion current density
High spatial focusing which improves many aspects of soft landing of ions

As used herein, including in the claims, unless the context indicates otherwise, singular forms of the terms herein are to be construed as including the plural form and vice versa. For instance, unless the context indicates otherwise, a singular reference herein including in the claims, such as “a” or “an” (such as an ion multipole device) means “one or more” (for instance, one or more ion multipole device). Throughout the description and claims of this disclosure, the words “comprise”, “including”, “having” and “contain” and variations of the words, for example “comprising” and “comprises” or similar, mean “including but not limited to”, and are not intended to (and do not) exclude other components. Also, the use of “or” is inclusive, such that the phrase “A or B” is true when “A” is true, “B is true”, or both “A” and “B” are true.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

The terms “first” and “second” may be reversed without changing the scope of the disclosure. That is, an element termed a “first” element may instead be termed a “second” element and an element termed a “second” element may instead be considered a “first” element.

Any steps described in this specification may be performed in any order or simultaneously unless stated or the context requires otherwise. Moreover, where a step is described as being performed after a step, this does not preclude intervening steps being performed.

It is also to be understood that, for any given component or embodiment described herein, any of the possible candidates or alternatives listed for that component may generally be used individually or in combination with one another, unless implicitly or explicitly understood or stated otherwise. It will be understood that any list of such candidates or alternatives is merely illustrative, not limiting, unless implicitly or explicitly understood or stated otherwise.

All literature and similar materials cited in this disclosure, including but not limited to patents, patent applications, articles, books, treaties and internet web pages are expressly incorporated by reference in their entirety for any purpose. Unless otherwise described, all technical and scientific terms used herein have a meaning as is commonly understood by one of ordinary skill in the art to which the various embodiments described herein belongs.

As will be appreciated by the skilled person, details of the above embodiment may be varied without departing from the scope of the present invention, as defined by the appended claims.

For example, a different number of curved and elongate electrodes may be used. In the case of a six-electrode device, the RF phases may be 0-180-0-180-0-180 degrees between neighbouring electrodes.

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

The following numbered clauses provide further example implementations:
1. An ion focusing device comprising:
   an ion collection element comprising:
      a plurality of N curved electrodes extending around an axis of the ion collection element; and
      an aperture on an axis of the ion collection element; and
      a multipole ion guide adjacent the ion collection element and having a plurality of N elongate electrodes extending parallel to and around an axis of the multipole ion guide, wherein the axis of the multipole ion guide coincides with the axis of the ion collection element,
   wherein each of the N curved electrodes of the ion collection element are configured to receive a radio frequency, RF, signal having the same phase as an RF signal configured to be applied to at least one elongate electrode of the plurality of elongate electrodes of the multipole ion guide, and further wherein at least two of the N electrodes of the ion collection element are configured to receive RF signals of a different phase. Preferably, a minimum distance between the curved electrodes and the corresponding ion guide electrodes is less than 0.5-1 of the inscribed diameter of the ion guide.
2. The ion focusing device of clause 1, wherein the plurality of N curved electrodes are separated by a constant distance along their lengths.
3. The ion focusing device of clause 1 or clause 2, wherein the N curved electrodes terminate adjacent to the aperture of the ion collection element.
4. The ion focusing device of clause 3, wherein the N curved electrodes terminate at an angular separation of 90 degrees or 180 degrees around the aperture.
5. The ion focusing device according to any previous clause, wherein each of the N curved electrodes are connected to one of the N elongate electrodes.
6. The ion focusing device according to any previous clause, wherein the ion collection element has four curved electrodes and the multipole ion guide has four elongate electrodes.
7. The ion focusing device according to any previous clause, wherein the N elongate electrodes of the multipole ion guide are distributed equally around the axis of the multipole ion guide, and wherein elongate electrodes at opposite positions around the axis are configured to receive an RF signal having the same phase and elongate electrodes at adjacent positions around the axis are configured to receive an RF signal at 180 degrees out of phase to each other.
8. The ion focusing device according to any previous clause, wherein the N curved electrodes are spirals, arithmetic or Archimedes spirals, conical helixes or circular.
9. The ion focusing device according to any previous clause, wherein the N curved electrodes are configured to receive a direct current, DC, offset voltage relative to the N elongate electrodes of the multipole ion guide.
10. The ion focusing device according to any previous clause further comprising electrical connections between each of the N curved electrodes of the ion collection element and each of the elongate electrodes of the multipole ion guide.
11. The ion focusing device of clause 10, wherein the electrical connections pass through the aperture intersecting with inner portions of the N curved electrodes.
12. The ion focusing device according to any previous clause, wherein N is an odd number.
13. The ion focusing device according to any of clauses 1 to 11, wherein N is an even number.
14. The ion focusing device according to any previous clause, wherein the N curved electrodes curve on plane.
15. The ion focusing device according to any previous clause, wherein the N curved electrodes form an ion funnel.
16. The ion focusing device according to any previous clause, wherein the ion collection element further comprises a substrate around the aperture.
17. The ion focusing device of clause 16, wherein the substrate is glass or a printed circuit board, PCB.
18. The ion focusing device of clause 16 or clause 17, wherein the substrate is 0.2 mm to 2 mm thick.
19. The ion focusing device according to any previous clause further comprising one or more alignment holes in the ion collection element and/or the multipole ion guide.
20. The ion focusing device according to any previous clause, wherein a volume within the multipole ion guide is filled with a buffer gas.
21. The ion focusing device of clause 20, wherein the buffer gas is at a pressure corresponding to a mean free path of ions in the range 0.01-10 times the inscribed diameter of the multipole ion guide.
22. The ion focusing device according to any previous clause, wherein an internal diameter of the multipole ion guide is 0.5 mm to 2 mm.
23. The ion focusing device according to any previous clause, wherein an internal diameter of the aperture is 0.5 mm to 2 mm.
24. The ion focusing device according to any previous clause, wherein the N curved electrodes and the elongate electrodes of the multipole ion guide are configured to receive an RF signal at the same frequency.
25. A mass spectrometer comprising the ion focusing device according to any previous clause.

1. An ion focusing device comprising:
an ion collection element comprising:
a plurality of N curved electrodes extending around an axis of the ion collection element; and
an aperture on an axis of the ion collection element; and
a multipole ion guide adjacent the ion collection element and having a plurality of N elongate electrodes extending parallel to and around an axis of the multipole ion guide, wherein the axis of the multipole ion guide coincides with the axis of the ion collection element,
wherein each of the N curved electrodes of the ion collection element are configured to receive a radio frequency, RF, signal having a same phase as an RF signal configured to be applied to at least one elongate electrode of the plurality of N elongate electrodes of the multipole ion guide, and further wherein at least two of the plurality of N elongate electrodes of the ion collection element are configured to receive RF signals of a different phase.

2. The ion focusing device of claim 1, wherein the plurality of N curved electrodes are separated by a constant distance along their lengths.

3. The ion focusing device of claim 1, wherein the N curved electrodes terminate adjacent to the aperture of the ion collection element.

4. The ion focusing device of claim 3, wherein the N curved electrodes terminate at an angular separation of 90 degrees or 180 degrees around the aperture.

5. The ion focusing device of claim 1, wherein each of the N curved electrodes are connected to one of the plurality of N elongate electrodes.

6. The ion focusing device of claim 1, wherein the ion collection element has four curved electrodes and the multipole ion guide has four elongate electrodes.

7. The ion focusing device of claim 1, wherein the plurality of N elongate electrodes of the multipole ion guide are distributed equally around the axis of the multipole ion guide, and wherein elongate electrodes at opposite positions around the axis are configured to receive an RF signal having the same phase and elongate electrodes at adjacent positions around the axis are configured to receive an RF signal at 180 degrees out of phase to each other.

8. The ion focusing device of claim 1, wherein the N curved electrodes are spirals, arithmetic or Archimedes spirals, conical helixes or circular.

9. The ion focusing device of claim 1, wherein the N curved electrodes are configured to receive a direct current, DC, offset voltage relative to the plurality of N elongate electrodes of the multipole ion guide.

10. The ion focusing device of claim 1 further comprising electrical connections between each of the N curved electrodes of the ion collection element and each of the plurality of N elongate electrodes of the multipole ion guide.

11. The ion focusing device of claim 5, wherein the electrical connections pass through the aperture.

12. The ion focusing device of claim 1, wherein N is an even number.

13. The ion focusing device of claim 1, wherein the N curved electrodes curve on plane.

14. The ion focusing device of claim 1, wherein the N curved electrodes form an ion funnel.

15. The ion focusing device of claim 1, wherein the ion collection element further comprises a substrate around the aperture.

16. The ion focusing device of claim 15, wherein the substrate is glass or a printed circuit board (PCB).

17. The ion focusing device of claim 1, wherein a volume within the multipole ion guide is filled with a buffer gas.

18. The ion focusing device of claim 1, wherein an internal diameter of the multipole ion guide and/or the aperture is 0.5 mm to 2 mm.

19. The ion focusing device of claim 1, wherein the N curved electrodes and the plurality of N elongate electrodes of the multipole ion guide are configured to receive an RF signal at the same frequency.

20. A mass spectrometer comprising the ion focusing device of claim 1.
